(19) United States
(12) Patent Application Publication
(10) Pub. No.: US 2012/0189323 A1
(43) Pub. Date: Jul. 26, 2012

(54) MULTI-LASER TRANSMITTER OPTICAL SUBASSEMBLY

(75) Inventors: Xiaojie Xu, Pleasanton, CA (US); Bernd Huebner, Santa Clara, CA (US)

(73) Assignee: FINISAR CORPORATION, Sunnyvale, CA (US)

(21) Appl. No.: 13/011,765

(22) Filed: Jan. 21, 2011

(51) Int. Cl. H04B 10/04

(52) U.S. Cl. 398/201

(57) ABSTRACT

Multi-laser transmitter optical subassembly (TOSAs) for an optoelectronic module. In one example embodiment, a method of fabricating a multi-laser TOSA includes various acts. First, first and second optical signals are transmitted from first and second lasers, respectively. Next, the angle of a first minor actively adjusted to reflect the first optical signal toward a first filter that reflects the first optical signal and transmits the second optical signal such that the first and second optical signals are aligned and combined.

### BACKGROUND

Optoelectronic modules, such as optoelectronic transceiver or transponder modules, are increasingly used in electronic and optoelectronic communication. Some modules can be plugged into a variety of host networking equipment. Modules typically communicate with a printed circuit board of a host device by transmitting electrical signals to the printed circuit board and receiving electrical signals from the printed circuit board. These electrical signals can then be transmitted by the module outside the host device as optical signals.

Multi-source agreements (MSAs), such as the C Form-factor Pluggable (CFP) MSA and the Quad Small Form-factor Pluggable (QSFP) MSA, specify, among other things, housing dimensions for modules. Conformity with an MSA allows a module to be plugged into host equipment designed in compliance with the MSA.

Optical signals are typically generated within a transmitter optical subassembly (TOSA) of a module using a laser, such as a vertical cavity surface emitting laser (VCSEL) or a distributed feedback (DFB) laser. As data rates in modules increase, two or more lasers are often included in a single TOSA. However, as MSAs specify increasingly smaller module housing dimensions, there is less available space for multi-laser TOSAs within the module housing. In addition, multi-laser TOSAs are often relatively expensive and often suffer from relatively high optical loss.

### BRIEF SUMMARY OF SOME EXAMPLE EMBODIMENTS

In general, example embodiments of the invention relate to a multi-laser transmitter optical subassembly (TOSA) for an optoelectronic module. The example multi-laser TOSA disclosed herein exhibits a relatively small size, cost, and optical loss, thus enabling relatively improved overall performance of the optoelectronic module into which the multi-laser TOSA is integrated.

In one example embodiment, a multi-laser TOSA includes first, second, third, and fourth lasers configured to generate first, second, third, and fourth optical signals having first, second, third, and fourth wavelengths, respectively; first, second, and third mirrors not positioned in the same or parallel planes; first, second, and third filters having first, second, and third filter surfaces facing the first, second, and third minors, respectively; and a focusing lens. The first minor is configured to reflect the first optical signal toward the first filter. The first filter is configured to combine the first and second optical signals. The second mirror is configured to reflect the combined first and second optical signals toward the second filter. The second filter is configured to combine the first, second, and third optical signals. The third mirror is configured to reflect the combined first, second, and third optical signals toward the third filter. The third filter is configured to both combine the first, second, third, and fourth optical signals and transmit the combined first, second, third, and fourth optical signals toward the focusing lens.

In another example embodiment, an optoelectronic transceiver module includes a printed circuit board, a receiver optical subassembly (ROSA) in electrical communication with the printed circuit board, and a multi-laser TOSA in electrical communication with the printed circuit board. The multi-laser TOSA includes first, second, third, and fourth lasers configured to generate first, second, third, and fourth optical signals having first, second, third, and fourth wavelengths, respectively; first, second, and third mirrors not positioned in the same or parallel planes; first, second, and third filters having first, second, and third filter surfaces facing the first, second, and third minors, respectively; and a focusing lens. The first minor is configured to reflect the first optical signal toward the first filter. The first filter is configured to both transmit the second optical signal and reflect the first optical signal toward the second minor. The second mirror is configured to reflect the combined first and second optical signals toward the second filter. The second filter is configured to both transmit the third optical signal and reflect the combined first and second optical signals toward the third mirror. The third minor is configured to reflect the combined first, second, and third optical signals toward the third filter. The third filter is configured to both transmit the fourth optical signal and reflect the combined first, second, and third optical signals toward the focusing lens.

In yet another example embodiment, a method of fabricating a multi-laser TOSA includes various acts. First, first and second optical signals are transmitted from first and second lasers, respectively. Next, the angle of a first minor actively adjusted to reflect the first optical signal toward a first filter that reflects the first optical signal and transmits the second optical signal such that the first and second optical signals are aligned and combined.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify certain aspects of the present invention, a more particular description of the invention will be rendered by reference to example embodiments thereof which are disclosed in the appended drawings. It is appreciated that these drawings depict only example embodiments of the invention and are therefore not to be considered limiting of its scope. Aspects of the invention will be described and explained with additional specificity and detail through the use of the accompanying drawings in which:

FIG. 1 is a perspective view of an example optoelectronic module and associated multi-laser transmitter optical subassembly (TOSA);

FIG. 2 is a schematic view of the example multi-laser TOSA of FIG. 1; and

FIG. 3 is a flowchart of an example method for fabricating the multi-laser TOSA of FIGS. 1 and 2.

### DETAILED DESCRIPTION OF SOME EXAMPLE EMBODIMENTS

Example embodiments of the present invention relate to a multi-laser transmitter optical subassembly (TOSA) for an optoelectronic module. The example multi-laser TOSA disclosed herein exhibits a relatively small size, cost, and optical loss, thus enabling relatively improved overall performance of the optoelectronic module into which the multi-laser TOSA is integrated.

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

### 1. Example Optoelectronic Module

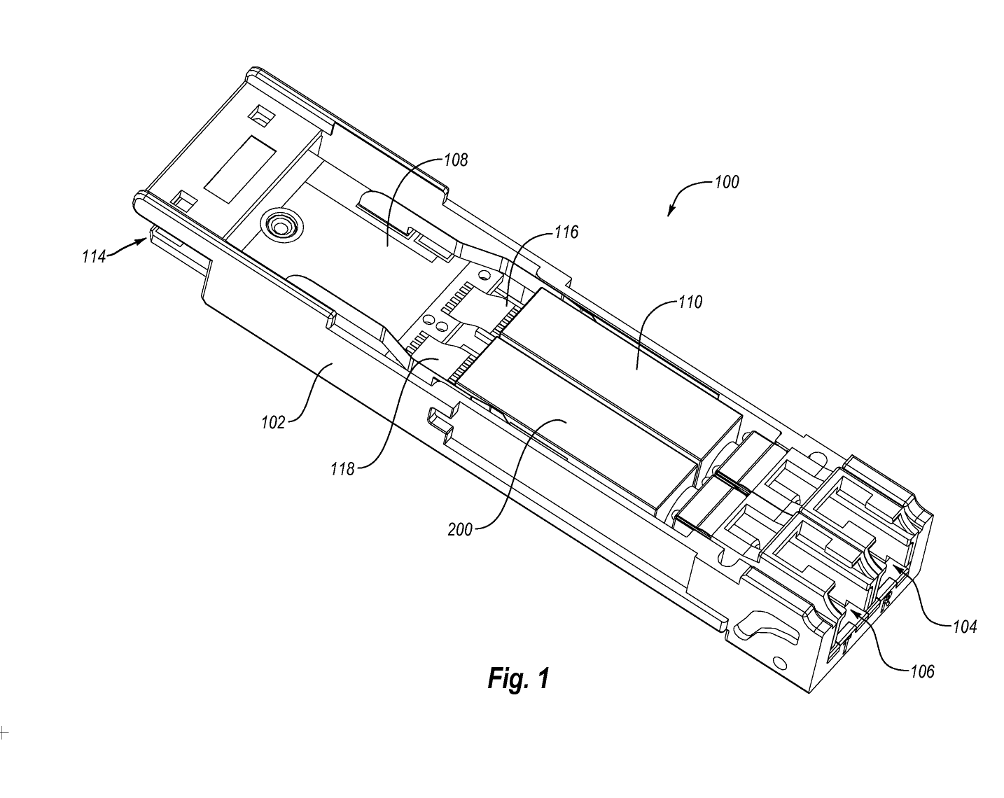

Reference is first made to FIG. 1 which discloses an example optoelectronic module 100 for use in transmitting and receiving optical signals in connection with a host device (not shown). The module 100 is one environment in which example embodiments of the invention can be practiced. As disclosed in FIG. 1, the module 100 includes various components, including a bottom housing 102 configured to mate with a top housing (not shown), a receive port 104 and a transmit port 106 defined in the bottom housing 102, a printed circuit board (PCB) 108 positioned within the bottom housing 102, a receiver optical subassembly (ROSA) 110, and a multi-laser TOSA 200. An edge connector 114 is located on an end of the PCB 108 to enable the module 100 to electrically interface with a host device (not shown). As such, the PCB 108 facilitates electrical communication between the ROSA 110/TOSA 200 and the host device.

The module 100 can be configured for optical signal transmission and reception at a variety of data rates including, but not limited to, 40 Gb/s, 100 Gb/s, or higher. Furthermore, the module 100 can be configured for optical signal transmission and reception at various distinct wavelengths using wavelength division multiplexing (WDM) in which multiple optical signals having distinct wavelengths are multiplexed onto a single optical fiber. For example, the module 100 can be configured to operate using one of various WDM schemes, such as Coarse WDM (CWDM), Dense WDM (DWDM), Light WDM (LWDM), or Local Area Network WDM (LAN WDM). Further, the module 100 can be configured to support various communication protocols including, but not limited to, Fibre Channel and High Speed Ethernet. In addition, although the example module 100 is configured to have a form factor that is substantially compliant with the QSFP MSA, the module 100 can alternatively be configured in a variety of different form factors that are substantially compliant with other MSAs including, but not limited to, the CFP MSA.

With continued reference to FIG. 1, the ROSA 110 houses an optical receiver such as a photodiode (not shown) that is electrically coupled to an electrical interface 116. The TOSA 200 houses multiple optical transmitters such as lasers (not shown) that are electrically coupled to the other electrical interface 118. The optical receiver is configured to convert optical signals received through the receive port 104 into corresponding electrical signals that are relayed to the PCB 108. The optical transmitter is configured to convert electrical signals received through the PCB 108 from a host device (not shown) into corresponding optical signals that are transmitted through the transmit port 106. Accordingly, the ROSA 110 serves as an optical-electronic transducer and the TOSA 200 serves as an electronic-optical transducer. The optical ports 104 and 106 are configured to optically connect the optical receiver and the optical transceiver, respectively, with optical fibers and corresponding optical fiber connectors such as LC or SC connectors (not shown) that are connected to the optical ports.

Having described a specific environment with respect to FIG. 1, it will be understood that this specific environment is only one of countless architectures in which example embodiments of the present invention may be employed. For example, the example multi-laser TOSA 200 can be employed in any optoelectronic transceiver, transmitter, or optical engine. The scope of the present invention is not intended to be limited to any particular environment.

### 2. Example Multi-Laser TOSA

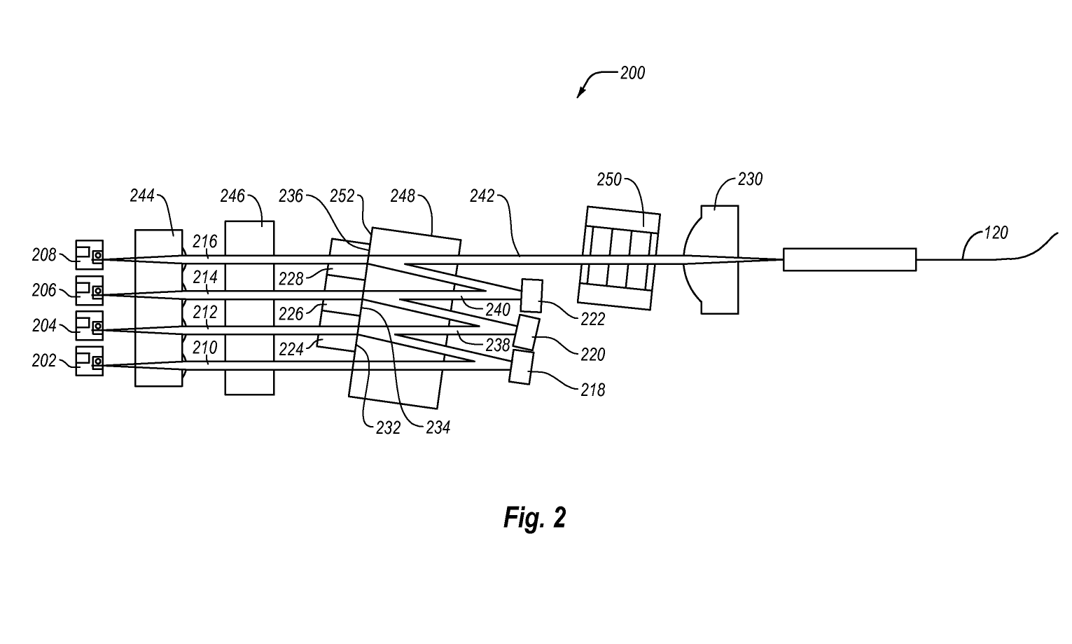

With reference now to FIG. 2, additional aspects of the example multi-laser TOSA 200 are disclosed. The TOSA 200 can be employed in a WDM environment in order to increase the data throughput on a single optical fiber 120. The optical fiber 120 may be single-mode or multi-mode optical fiber. Although not shown in FIG. 2, it is understood that the various components of the example TOSA 200 can be hermetically sealed within a package.

As disclosed in FIG. 2, the TOSA 200 includes first, second, third, and fourth lasers 202-208 configured to generate first, second, third, and fourth optical signals 210-216, respectively. The lasers 202-208 may be distributed feedback lasers (DFBs), for example. Each of the optical signals 210-216 has a distinct wavelength. The TOSA 200 also includes first, second, and third mirrors 218-222 and first, second, and third filters 224-228 as well as a focusing lens 230.

The first, second, and third filters 224-228 may be thin film filters, for example, and have first, second, and third filter surfaces 232-236 facing the first, second, and third minors 218-222, respectively. The first, second, and third minors 218-222 are each individually and precisely aligned with the first, second, and third filter surfaces 232-236, respectively. Being individually and precisely aligned, the first, second, and third minors 218-222 are not positioned in the same or parallel planes.

The first minor 218 is configured to reflect the first optical signal 210 toward the first filter surface 232 of the first filter 224. The first filter 224 is configured to both transmit the second optical signal 212 and reflect the first optical signal 210 toward the second minor 220. The second minor 220 is configured to reflect the combined first and second optical signals 238 toward the second filter surface 234 of the second filter 226. The second filter 226 is configured to both transmit the third optical signal 214 and reflect the combined first and second optical signals 238 toward the third mirror 222. The third minor 222 is configured to reflect the combined first, second, and third optical signals 240 toward the third filter 222. The third filter is configured to both transmit the fourth optical signal 216 and reflect the combined first, second, and third optical signals 242 toward the focusing lens 230.

As disclosed in FIG. 2, the TOSA 200 may also include a collimating lens array 244 positioned between the lasers 202-208 and the filters 224-228, a beam splitter 246 positioned between the collimating lens array 244 and the filters 224-228, a wavelength division multiplexing (WDM) block 248 positioned between the filters 224-228 and the mirrors 218-222, and an isolator 250 positioned between the third filter 228 and the focusing lens 230. The beam splitter 246 may transmit between about 80% and 99% of each optical signal and reflect between about 20% and about 1% of each optical signal, for example, and may be employed in connection with monitoring photodiodes (not shown). The WDM block 248 may have a surface 252 to which the first, second, and third filter surfaces 232-236 of the first, second, and third filters 224-228, respectively, are attached. In some example embodiments, the surface 252 may be a substantially planar surface such that first, second, and third filter surfaces 232-236 are substantially positioned in the same plane. The isolator 250 reduces or prevents back reflection from reaching the lasers 202-208.

### 3. Example Multi-Laser TOSA Fabrication Method

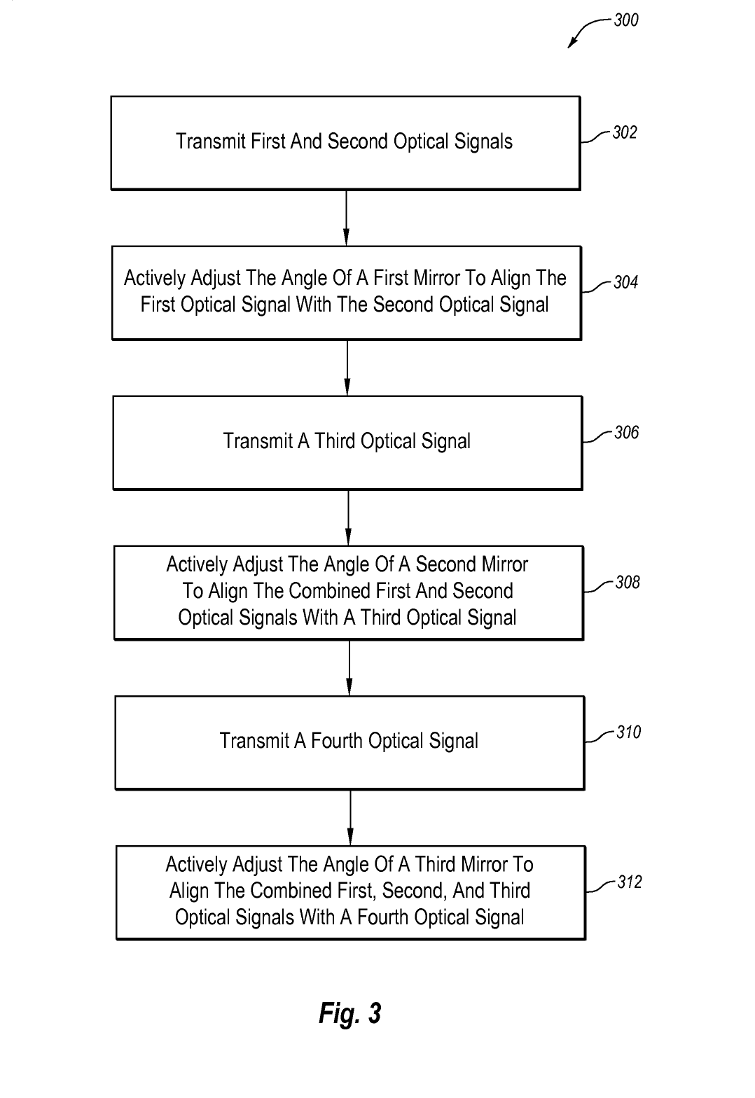

With continued reference to FIG. 2, and with reference also to FIG. 3, aspects of an example method 300 of fabricating the multi-laser TOSA 200 are disclosed.

At act 302, the first and second optical signals 210 and 212 are transmitted from the first and second lasers 202 and 204, respectively. For example, the first optical signal 210 may be transmitted through the collimating lens array 244, the beam splitter 246, and the WDM block 248 toward the first mirror 218. Simultaneously, the second optical signal 212 may be transmitted through the collimating lens array 244 and the beam splitter 246 toward the first filter 224.

At act 304, the angle of the first mirror 218 is actively adjusted to reflect the first optical signal 210 toward the first filter 224 such that the first and second optical signals 210 and 212 are aligned and combined. For example, the angle of the first minor 218 can be actively adjusted and then fixed in place. The first minor 218 may be fixed in place by affixing the first minor 218 to a substrate (not shown) with a high-viscosity low-shrinking ultraviolet epoxy and then curing the epoxy once the first minor has been actively adjusted. Alternatively, the first minor 218 may be part of a microelectromechanical system (MEMS) mirror array that is electronically tuned during active alignment.

At act 306, the third optical signal 214 is transmitted from the third laser 206. For example, the third optical signal 214 may be transmitted through the collimating lens array 244 and the beam splitter 246 toward the second filter 226.

At act 308, the angle of the second mirror 220 is actively adjusted to reflect the combined first and second optical signals 238 toward the second filter 226 such that the first, second, and third optical signals 210, 212, and 214 are aligned and combined. For example, the angle of the second minor 220 can be actively adjusted and then fixed in place in a manner similar to the active adjustment and fixing in place of the first minor 218. It is noted that since the first and second mirrors 218 and 220 are each individually and precisely aligned with the first and second filter surfaces 232 and 234 of the first and second filters 224 and 226, respectively, the first and second minors 218 and 220 may not be fixed in position in the same or parallel planes.

At act 310, the fourth optical signal 216 is transmitted from the fourth laser 208. For example, the fourth optical signal 216 may be transmitted through the collimating lens array 244 and the beam splitter 246 toward the third filter 228.

At act 312, the angle of the third minor 222 is actively adjusted to reflect the combined first, second, and third optical signals 240 toward the third filter 228 such that the first, second, third, and fourth optical signals 210-216 are aligned and combined. For example, the angle of the third mirror 222 can be actively adjusted and then fixed in place in a manner similar to the active adjustment and fixing in place of the first and second minors 218 and 220. It is noted that since the first, second, and third mirrors 218-222 are each individually and precisely aligned with the first, second, and third filter surfaces 232-236 of the first, second, and third filters 224-228, respectively, the first, second, and third mirrors 218-222 may not be fixed in position in the same or parallel planes.

In at least some example embodiments, the angles of the first, second, and third mirrors 218-222 are each actively adjusted such that the difference between the angle of incidence and the angle of reflection for each of the minors 218-222 is between about 4 degrees and about 16 degrees.

Although not shown in FIG. 3, it is understood that the method 300 can further include acts of positioning the collimating lens array 244 between the lasers 202-208 and the filters 224-228, positioning the beam splitter 246 between the collimating lens array 244 and the filters 224-228, positioning the focusing lens 230 so as to be optically aligned with the third filter 228, positioning the isolator 250 between the third filter 228 and the focusing lens 230, and hermetically sealing a package around the lasers 202-208, filters 224-228, minors 218-222, collimating lens array 244, beam splitter 246, focusing lens 230, and isolator 250.

It is also understood that TOSA 200 could be modified to have less than or greater than four lasers and three minors and still benefit from the individual and precise active adjustment of TOSA minors. For example, the TOSA 200 could have only two lasers and a single mirror that is actively adjusted. Alternatively, the TOSA 200 could have six lasers and five minors that at are each actively adjusted. The discussion of TOSAs herein is therefore not limited to TOSAs having four lasers and three minors.

The individual and precise active adjustment of each of the mirrors 218-222 in the example multi-laser TOSA 200 enables the combination of multiple optical signals with relatively low optical loss. The size and cost of the example multi-laser TOSA 200 are also relatively low compared to prior art multi-laser TOSAs. The individual and precise active adjustment of each of the mirrors 218-222 in the example multi-laser TOSA 200 thus enables the example multi-laser TOSA 200 to exhibit relatively small size, cost, and optical loss. Consequently, optoelectronic modules into which the example multi-laser TOSA 200 is integrated also exhibit relatively improved overall performance.

The example embodiments disclosed herein may be embodied in other specific forms. The example embodiments disclosed herein are to be considered in all respects only as illustrative and not restrictive.

What is claimed is:

1. A multi-laser transmitter optical subassembly (TOSA) comprising:
first, second, third, and fourth lasers configured to generate first, second, third, and fourth optical signals having first, second, third, and fourth wavelengths, respectively;
first, second, and third mirrors not positioned in the same or parallel planes;
first, second, and third filters having first, second, and third filter surfaces facing the first, second, and third minors, respectively; and
a focusing lens,
wherein the first minor is configured to reflect the first optical signal toward the first filter, the first filter is configured to combine the first and second optical signals, the second minor is configured to reflect the combined first and second optical signals toward the second filter, the second filter is configured to combine the first, second, and third optical signals, the third minor is configured to reflect the combined first, second, and third optical signals toward the third filter, and the third filter is configured to both combine the first, second, third, and fourth optical signals and transmit the combined first, second, third, and fourth optical signals toward the focusing lens.

2. The multi-laser TOSA as recited in claim 1, further comprising a collimating lens array positioned between the lasers and the filters.

3. The multi-laser TOSA as recited in claim 2, further comprising a beam splitter positioned between the collimating lens array and the filters.

4. The multi-laser TOSA as recited in claim 3, wherein the beam splitter is configured to transmit between about 80% and 99% of each optical signal and reflect between about 20% and about 1% of each optical signal.

5. The multi-laser TOSA as recited in claim 1, further comprising a wavelength division multiplexing (WDM) block having a surface to which the first, second, and third filter surfaces of the first, second, and third filters, respectively, are attached.

6. The multi-laser TOSA as recited in claim 1, further comprising an isolator positioned between the third filter and the focusing lens.

7. The multi-laser TOSA as recited in claim 1, wherein the first, second, and third filter surfaces are substantially positioned in the same plane.

8. The multi-laser TOSA as recited in claim 1, wherein the first mirror is configured such that the difference between the angle of incidence of the first optical signal and the angle of reflection of the first optical signal is between about 4 degrees and about 16 degrees.

9. The multi-laser TOSA as recited in claim 1, wherein the second mirror is configured such that the difference between the angle of incidence of the combined first and second optical signals and the angle of reflection of the combined first and second optical signals is between about 4 degrees and about 16 degrees.

10. The multi-laser TOSA as recited in claim 1, wherein the third minor is configured such that the difference between the angle of incidence of the combined first, second, and third optical signals and the angle of reflection of the combined first, second, and third optical signals is between about 4 degrees and about 16 degrees.

11. An optoelectronic transceiver module comprising:
a printed circuit board;
a receiver optical subassembly (ROSA) in electrical communication with the printed circuit board; and
a multi-laser TOSA in electrical communication with the printed circuit board, the multi-laser TOSA comprising:
first, second, third, and fourth lasers configured to generate first, second, third, and fourth optical signals having first, second, third, and fourth wavelengths, respectively;
first, second, and third minors not positioned in the same or parallel planes;
first, second, and third filters having first, second, and third filter surfaces facing the first, second, and third minors, respectively; and
a focusing lens,
wherein the first minor is configured to reflect the first optical signal toward the first filter, the first filter is configured to both transmit the second optical signal and reflect the first optical signal toward the second mirror, the second mirror is configured to reflect the combined first and second optical signals toward the second filter, the second filter is configured to both transmit the third optical signal and reflect the combined first and second optical signals toward the third minor, the third minor is configured to reflect the combined first, second, and third optical signals toward the third filter, and the third filter is configured to both transmit the fourth optical signal and reflect the combined first, second, and third optical signals toward the focusing lens.

12. The optoelectronic transceiver module as recited in claim 11, further comprising a collimating lens array positioned between the lasers and the filters.

13. The optoelectronic transceiver module as recited in claim 12, further comprising a beam splitter positioned between the collimating lens array and the filters, wherein the beam splitter is configured to transmit between about 80% and 99% of each optical signal and reflect between about 20% and about 1% of each optical signal.

14. The optoelectronic transceiver module as recited in claim 11, further comprising a wavelength division multiplexing (WDM) block having a substantially planar surface to which the first, second, and third filter surfaces of the first, second, and third filters, respectively, are attached, such that first, second, and third filter surfaces are substantially positioned in the same plane.

15. The optoelectronic transceiver module as recited in claim 11, further comprising an isolator positioned between the third filter and the focusing lens.

16. A method of fabricating a multi-laser TOSA, the method comprising the acts of:
transmitting first and second optical signals from first and second lasers, respectively; and
actively adjusting the angle of a first mirror to reflect the first optical signal toward a first filter that reflects the first optical signal and transmits the second optical signal such that the first and second optical signals are aligned and combined.

17. The method as recited in claim 16, the method further comprising the acts of:
transmitting a third optical signal from a third laser; and
actively adjusting the angle of a second minor to reflect the combined first and second optical signals toward a second filter that reflects the combined first and second optical signals and transmits the third optical signal such that the first, second, and third optical signals are aligned and combined.

18. The method as recited in claim 17, the method further comprising the acts of:
transmitting a fourth optical signal from a fourth laser; and
actively adjusting the angle of a third mirror to reflect the combined first, second, and third optical signals toward a third filter that reflects the combined first, second, and third optical signals and transmits the fourth optical signal such that the first, second, third, and fourth optical signals are aligned.

19. The method as recited in claim 18, wherein the first mirror angle, the second minor angle, and the third minor angle are each actively adjusted such that the difference between the angle of incidence and the angle of reflection for each mirror is between about 4 degrees and about 16 degrees.

20. The method as recited in claim 18, further comprising the acts of:
positioning a collimating lens array between the lasers and the filters;
positioning a focusing lens so as to be optically aligned with the third filter;
positioning an isolator between the third filter and the focusing lens; and
hermetically sealing a package around the lasers, filters, minors, collimating lens array, focusing lens, and isolator.
